(19) United States
(12) Patent Application Publication
(10) Pub. No.: US 2024/0321005 A1
(43) Pub. Date: Sep. 26, 2024

(54) AUTHENTICATION SYSTEM, AUTHENTICATION APPARATUS, AUTHENTICATION METHOD, AND RECORDING MEDIUM

(71) Applicant: NEC Corporation, Minato-ku, Tokyo (JP)

(72) Inventor: Akihiro Hayasaka, Tokyo (JP)

(73) Assignee: NEC Corporation, Minato-ku, Tokyo (JP)

(21) Appl. No.: 18/271,653

(22) PCT Filed: Jul. 9, 2021
(86) PCT No.: PCT/JP2021/025990

§ 371 Date: Jul. 10, 2023

(51) Int. Cl. G06V 40/16; G06V 20/50; G06V 40/50

(52) U.S. Cl. CPC G06V 40/172; G06V 20/50; G06V 40/166; G06V 40/50

(57) ABSTRACT

An authentication system includes: a first acquisition unit that obtains face information and environment information of a target, from an image including the target; a second acquisition unit that obtains imaging angle information that is information indicating an angle when the image is captured; and an authentication execution unit that performs an authentication process on the target, on the basis of the obtained face information, the obtained environment information, and the obtained imaging angle information. According to such an authentication system, it is possible to properly perform the authentication process.

### TECHNICAL FIELD

This disclosure relates to technical fields of an authentication system, an authentication apparatus, an authentication method, and a recording medium that authenticate a target.

### BACKGROUND ART

A system that uses information other than a face in face authentication is known as a system of this type. For example, Patent Literature 1 discloses a technique/technology of using a background image when a user is imaged. Patent Literature 2 discloses a technique/technology of preventing spoofing by using a background image. Patent Literature 3 discloses a technique/technology of collating/verifying a feature quantity of an object located around a face.

### CITATION LIST

### Patent Literature

Patent Literature 1: JP2004-362079A
Patent Literature 2: JP2007-011456A
Patent Literature 3: JP2013-191066A

### SUMMARY

### Technical Problem

This disclosure aims to improve the techniques/technologies disclosed in Citation List.

### Solution to Problem

An authentication system according to an example aspect of this disclosure includes: a first acquisition unit that obtains face information and environment information of a target, from an image including the target; a second acquisition unit that obtains imaging angle information that is information indicating an angle when the image is captured; and an authentication execution unit that performs an authentication process on the target, on the basis of the obtained face information, the obtained environment information, and the obtained imaging angle information.

An authentication apparatus according to an example aspect of this disclosure includes: a first acquisition unit that obtains face information and environment information of a target, from an image including the target; a second acquisition unit that obtains imaging angle information that is information indicating an angle when the image is captured; and an authentication execution unit that performs an authentication process on the target, on the basis of the obtained face information, the obtained environment information, and the obtained imaging angle information.

An authentication method according to an example aspect of this disclosure includes: obtaining face information and environment information of a target, from an image including the target; obtaining imaging angle information that is information indicating an angle when the image is captured; and performing an authentication process on the target, on the basis of the obtained face information, the obtained environment information, and the obtained imaging angle information.

A recording medium according to an example aspect of this disclosure is a recording medium on which a computer program that allows a computer to execute an authentication method is recorded, the authentication method including: obtaining face information and environment information of a target, from an image including the target; obtaining imaging angle information that is information indicating an angle when the image is captured; and performing an authentication process on the target, on the basis of the obtained face information, the obtained environment information, and the obtained imaging angle information.

### BRIEF DESCRIPTION OF DRAWINGS

FIG. 1 is a block diagram illustrating a hardware configuration of an authentication system according to a first example embodiment.

FIG. 2 is a block diagram illustrating a functional configuration of the authentication according to the first example embodiment.

FIG. 3 is a block diagram illustrating a functional configuration of an authentication system according to a modified example of the first example embodiment.

FIG. 4 is a flowchart illustrating a flow of operation of the authentication system according to the first example embodiment.

FIG. 5 is a flowchart illustrating a flow of operation when registered information is recorded in an authentication system according to a second example embodiment.

FIG. 6A to FIG. 6C are diagrams illustrating an example of a plurality of images recorded in the authentication system according to the second example embodiment.

FIG. 7A to FIG. 7C are diagrams illustrating a display example when images are captured in the authentication system according to the second example embodiment.

FIG. 8 is a block diagram illustrating a functional configuration of an authentication system according to a third example embodiment.

FIG. 9 is a flowchart illustrating a flow of operation of the authentication system according to the third example embodiment.

FIG. 10 is a block diagram illustrating a functional configuration of an authentication according to a fourth example embodiment.

FIG. 11 is a flowchart illustrating a flow of operation of the authentication system according to the fourth example embodiment.

FIG. 12 is a block diagram illustrating a functional configuration of an authentication according to a fifth example embodiment.

FIG. 13 is a flowchart illustrating a flow of operation of the authentication system according to the fifth example embodiment.

FIG. 14 is a block diagram illustrating a functional configuration of an authentication according to a sixth example embodiment.

FIG. 15 is a flowchart illustrating a flow of operation of the authentication system according to the sixth example embodiment.

FIG. 16 is a block diagram illustrating a functional configuration of an authentication according to a seventh example embodiment.

FIG. 17 is a flowchart illustrating t a flow of operation of the authentication system according to the seventh example embodiment.

FIG. 18 is a block diagram illustrating a functional configuration of an authentication according to an eighth example embodiment.

FIG. 19 is a flowchart illustrating a flow of operation of the authentication system according to the eighth example embodiment.

FIG. 20 is a block diagram illustrating a functional configuration of an authentication according to a ninth example embodiment.

FIG. 21 is version 1 of a diagram illustrating a display example in the authentication system according to the ninth example embodiment.

FIG. 22 is version 2 of a diagram illustrating a display example in the authentication system according to the ninth example embodiment.

FIG. 23 is version 3 of a diagram illustrating a display example in the authentication system according to the ninth example embodiment.

FIG. 24 is a block diagram illustrating a functional configuration of an authentication system according to a tenth example embodiment.

FIG. 25 is a flowchart illustrating a flow of a stereoscopic determination operation in the authentication system according to the tenth example embodiment.

### DESCRIPTION OF EXAMPLE EMBODIMENTS

Hereinafter, an authentication system, an authentication apparatus, an authentication method, and a recording medium according to example embodiments will be described with reference to the drawings.

### First Example Embodiment

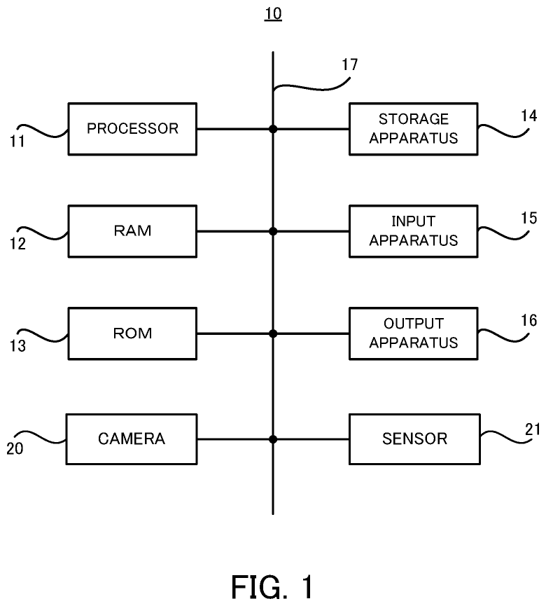

An authentication system according to a first example embodiment will be described with reference to FIG. 1 to FIG. 4.

### (Hardware Configuration)

First, a hardware configuration of an authentication system 10 according to the first example embodiment will be described with reference to FIG. 1. FIG. 1 is a block diagram illustrating the hardware configuration of the authentication system according to the first example embodiment.

As illustrated in FIG. 1, the authentication system 10 according to the first example embodiment includes a processor 11, a RAM (Random Access Memory) 12, a ROM (Read Only Memory) 13, and a storage apparatus 14. The authentication system 10 may further include an input apparatus 15, an output apparatus 16, a camera 20, and a sensor 21. The processor 11, the RAM 12, the ROM 13, the storage apparatus 14, the input apparatus 15, the output apparatus 16, the camera 20, and the sensor 21 are connected through a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer-readable recording medium by using a not-illustrated recording medium reading apparatus. The processor 11 may obtain (or read) a computer program from a not-illustrated apparatus disposed outside the authentication system 10, through a network interface. The processor 11 controls the RAM 12, the storage apparatus 14, the input apparatus 15, and the output apparatus 16 by executing the read computer program. Especially in this example embodiment, when the processor 11 executes the read computer program, a functional block for performing an authentication process on a target is realized or implemented in the processor 11.

The processor 11 may be configured as, for example, a CPU (Central Processing Unit), a GPU (Graphics Processing Unit), a FPGA (field-programmable gate array), a DSP (Digital Signal Processor) or an ASIC (Application Specific Integrated Circuit). The processor 11 may include one of them, or may use a plurality of them in parallel.

The RAM 12 temporarily stores the computer program to be executed by the processor 11. The RAM 12 temporarily stores the data that is temporarily used by the processor 11 when the processor 11 executes the computer program. The RAM 12 may be, for example, a D-RAM (Dynamic RAM).

The ROM 13 stores the computer program to be executed by the processor 11. The ROM 13 may otherwise store fixed data. The ROM 13 may be, for example, a P-ROM (Programmable ROM).

The storage apparatus 14 stores the data that is stored for a long term by the authentication system 10. The storage apparatus 14 may operate as a temporary storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the authentication system 10. The input apparatus 15 may include, for example, at least one of a keyboard, a mouse, and a touch panel.

The output apparatus 16 is an apparatus that outputs information about the authentication system 10 to the outside. For example, the output apparatus 16 may be a display apparatus (e.g., a display) that is configured to display the information about authentication system 10. In addition, the output apparatus 16 may be a speaker that is configured to audio-output the information about the authentication system 10.

The camera 20 is a camera installed at a position where an image of the user (e.g., an image including a face of the user) can be captured. The user here is not limited to only a human, and may include an animal like a dog, a snake, a robot, and the like. The camera 20 may be a camera that captures a still image, or a camera that captures a video. The camera 20 may be configured as a visible light camera or as a near infrared camera. The camera 20 may be provided, for example, in a portable terminal or the like.

The sensor 21 is a sensor that is configured to detect various information used in the system. A plurality of sensors 21 may be provided. A plurality of types of sensors 21 may be provided. Especially, the sensor 21 according to this example embodiment includes a sensor that detects an imaging angle of the camera 20. The sensor may be, for example, a gyro sensor or an acceleration sensor.

FIG. 1 exemplifies the authentication system 10 including a plurality of apparatuses, but all or a part of the functions may be realized or implemented by a single apparatus (authentication apparatus). This authentication apparatus may only include, for example, the processor 11, the RAM 12, and the ROM 13, and the other components (i.e., the storage apparatus 14, the input apparatus 15, the output apparatus 16, the camera 20, and the sensor 21) may be, for example, external components connected to the authentication apparatus.

### (Functional Configuration)

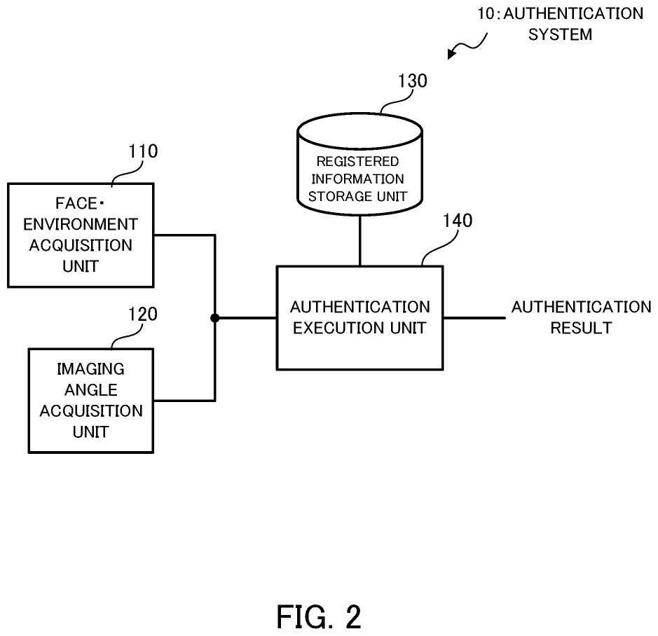

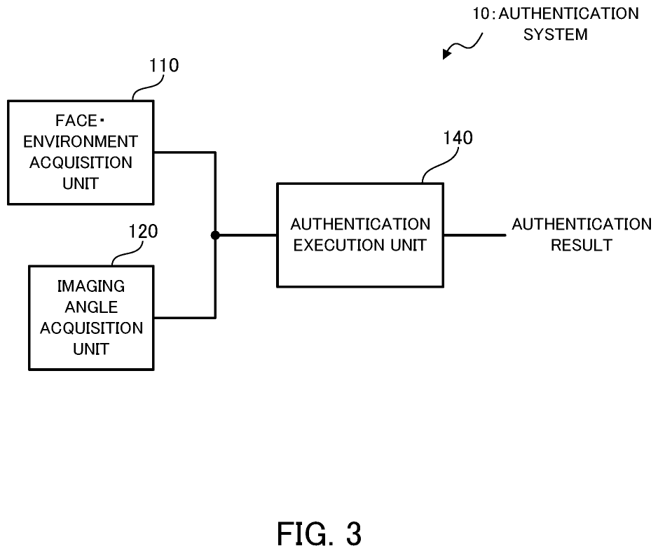

Next, a functional configuration of the authentication system 10 according to the first example embodiment will be described with reference to FIG. 2 and FIG. 3. FIG. 2 is a block diagram illustrating the functional configuration of the authentication according to the first example embodiment. FIG. 3 is a block diagram illustrating a functional configuration of an authentication system according to a modified example of the first example embodiment.

As illustrated in FIG. 2, the authentication system 10 according to the first example embodiment includes, as processing blocks for realizing the functions thereof, a face/environment acquisition unit 110, an imaging angle acquisition unit 120, a registered information storage unit 130, and an authentication execution unit 140. The face/environment acquisition unit 110, the imaging angle acquisition unit 120, and the authentication execution unit 140 may be realized or implemented by the processor 11 (see FIG. 1), for example. The registered information storage unit 130 may include, for example, the storage apparatus 14 (see FIG. 1).

The face/environment acquisition unit 110 is configured to obtain, from an image of a target that is a target of an authentication process, information about a face of the target (hereinafter referred to as a “face information” as appropriate) and information about an environment when the image is captured (hereinafter referred to as an “environment information” as appropriate). The environment information is information about other than the target (e.g., a background and a landscape) included in the image. The image of the target may be obtained by the camera 20 (see FIG. 1). The face information and the environment information may be obtained as a face image and an environment image (e.g., a background image and a landscape image), or may be obtained as a feature quantity indicating the face and the environment. A detailed description of a specific method of obtaining the face information and the environment information from the image will be omitted here because the existing techniques/technologies can be adopted to the method, as appropriate. The face information and the environment information obtained by the face/environment acquisition unit 110 are configured to be outputted to the authentication execution unit 140.

The imaging angle acquisition unit 120 is configured to obtain information indicating an angle (hereinafter referred to as an “imaging angle information”) when the image of the target (i.e., the image from which the face information and the environment information are obtained) is captured. The imaging angle information may be, for example, information indicating an angle of a terminal that captures the image. The imaging angle may be, for example, an angle indicating a single value such as “90 degrees”, or may be information having a width such as “80 to 90 degrees.” The imaging angle information may be obtained, for example, from the sensor 21 (e.g., gyro sensor) provided in the terminal. The imaging angle information may be two-dimensional angle information (e.g., information indicating the angle on a plane defined by an X-axis and a Y-axis: specifically, information indicating the angle in a vertical direction and in a lateral direction), or may be three-dimensional angle information (e.g., information indicating the angle on a three-dimensional space defined by the X-axis, Y-axis and a Z-axis: specifically, information indicating the angle in the vertical direction, in the lateral direction, and in a depth direction). The imaging angle information obtained by the imaging angle acquisition unit 120 is configured to be outputted to the authentication execution unit 140.

The registered information storage unit 130 stores the face information, the environment information, and the imaging angle information as registered information in advance. The registered information may be information obtained by the face/environment acquisition unit 110 and the imaging angle acquisition unit 120. That is, the registered information may be information obtained from the image of the target captured in advance. The registered information storage unit 130 may store the registered information for a plurality of registered users.

The registered information storage unit 130 may be configured to update, add, and delete the registered information as appropriate. The registered information stored in the registered information storage unit 130 is configured to be readable by the authentication execution unit 140 as appropriate.

The authentication execution unit 140 is configured to perform an authentication process on the target, on the basis of the face information and the environment information obtained by the face/environment acquisition unit 110, the imaging angle information obtained by the imaging angle acquisition unit 120, and the registered information stored in the registered information storage unit 130. The authentication execution unit 140 may be configured to perform a collation/verification process using the face information, the environment information, and the imaging angle information (e.g., a process of determining a degree of matching between the obtained information and the registered information). Specific contents of the authentication process will be described in detail in another example embodiment described later. The authentication execution unit 140 may be configured to output a result of the authentication process.

As illustrated in FIG. 3, the authentication system 10 according to the first example embodiment may include, as processing blocks for realizing the functions thereof, the face/environment acquisition unit 110, the imaging angle acquisition unit 120, and the authentication execution unit 140. That is, the authentication system 10 may be configured without the registered information storage unit 130. In this case, the authentication execution unit 140 may be configured to perform the authentication process on the target, on the basis of only the face information and the environment information obtained by the face/environment acquisition unit 110, and the imaging angle information obtained by the imaging angle acquisition unit 120. For example, the authentication execution unit 140 may be configured not to perform the authentication process when it can be determined that the environment information or the imaging angle information is abnormal (e.g., when the sky or a clock is captured even though the camera is directed downward, or when the ground is captured even though the camera is directed upward). Such anomalies are detectable, for example, by registering a background that is strange to be captured (an NG background) for each imaging angle and by determining whether or not the obtained environment information indicates the NG background.

### (Flow of Operation)

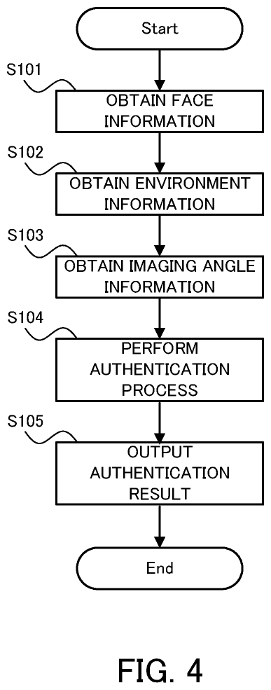

Next, with reference to FIG. 4, a flow of operation of the authentication system 10 according to the first example embodiment will be described. FIG. 4 is a flowchart illustrating the flow of the operation of the authentication system according to the first example embodiment.

As illustrated in FIG. 4, in operation of the authentication system 10 according to the first example embodiment, first, the face/environment acquisition unit 110 obtains the face information about the target from the image of the target (step S101). In addition, the face/environment acquisition unit 110 obtains the environment information from the image of the target (step S102). Then, the imaging angle acquisition unit 120 obtains the imaging angle information when the image is captured (step S103). The steps of obtaining the respective information (i.e., the steps S101 to S103) may be performed before or after one another, or may be performed at the same time in parallel.

Subsequently, the authentication execution unit 140 executes the authentication process, on the basis of the obtained face information, the obtained environment information, and the obtained imaging angle information (step S104). As illustrated in FIG. 2, when the registered information storage unit 130 is provided, the authentication execution unit 140 may perform the authentication process, on the basis of the face information, the environment information, the imaging angle information, and the registered information. On the other hand, as illustrated in FIG. 3, when the registered information storage unit 130 is provided, the authentication execution unit 140 may perform the authentication process, on the basis of the face information, the environment information, and the imaging angle information. Then, the authentication execution unit 140 outputs the result of the authentication process (e.g., information such as “the authentication is successful” or “the authentication is failed”, etc.) (step S105). The authentication execution unit 140 may output the authentication result by using a display, a speaker, or the like provided in the output apparatus 16 (see FIG. 1), for example.

### Technical Effect

Next, a technical effect obtained by the authentication system 10 according to the first example embodiment will be described.

As described in FIG. 1 to FIG. 4, in the authentication system 10 according to the first example embodiment, the authentication process is performed on the target, on the basis of the face information, the environment information, and the imaging angle information. In this way, not only the information about the face of the target but also the information about its surroundings and the imaging angle is used, and it is thus possible to perform the authentication process more properly. Consequently, it is possible to detect a fraud caused by spoofing or the like, for example. Specifically, when the authentication is performed by using only the face image and the environment image (e.g., the background image), there is a possibility that a fraud such as spoofing, by falsification using a counterfeit face image or environment image. In contrast, according to the authentication system in the first example embodiment, not only the face image and the environment image, but also the information about the imaging angle when these images are captured is used, and it is thus possible to prevent a fraud more effectively.

### Second Example Embodiment

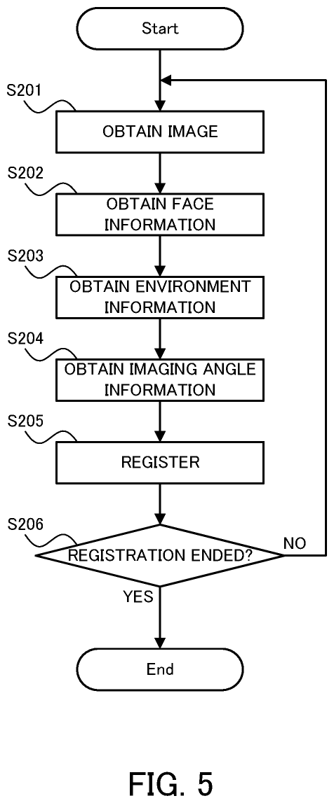

The authentication system 10 according to a second example embodiment will be described with reference to FIG. 5 to FIG. 7C. The second example embodiment is partially different from the first example embodiment only in the operation, and may be the same as the first example embodiment in the other parts. For this reason, apart that is different from the first example embodiment described above will be described in detail below, and a description of other overlapping parts will be omitted as appropriate.

### (Flow of Operation)

First, with reference to FIG. 5, a flow of operation of the authentication system 10 according to the second example embodiment (specifically, a flow of operation when the registered information is recorded) will be described. FIG. 5 is a flowchart illustrating the flow of the operation when the registered information is recorded in the authentication system according to the second example embodiment.

As illustrated in FIG. 5, when the authentication system 10 according to the second example embodiment stores the registered information, first, the image of the target to be registered is obtained (step S201). Then, from the image, the face/environment acquisition unit 110 obtains the face information about the target (step S202). In addition, the face/environment acquisition unit 110 obtains the environment information from the image of the target (step S203). Then, the imaging angle acquisition unit 120 obtains the imaging angle information when the image is captured (step S204).

Subsequently, the registered information storage unit 130 stores the obtained face information, the obtained environment information, and the obtained imaging angle information, as the registered information (step S205). Then, the registered information storage unit 130 determines whether or not all the registrations is ended (step S206). The determination here may be performed to determine whether or not the registration is ended for a predetermined number of images. In other words, it may be determined whether or not the number of registrations reaches a preset number of times.

When it is determined that all the registrations is not ended (step S206: NO), the process is repeated from the step S201. In the step S201 for the second time or after, however, the image captured at a different imaging angle from that of the images captured before is obtained. That is, the target to be registered is imaged a plurality of times by changing the imaging angle. By repeating such a process, the registered information storage unit 130 stores a plurality of pieces of face information, environment information, and imaging angle information for a single target. When it is determined that all the registrations is ended (step S206: YES), a sequence of processing steps is ended.

### (Specific Example of Image)

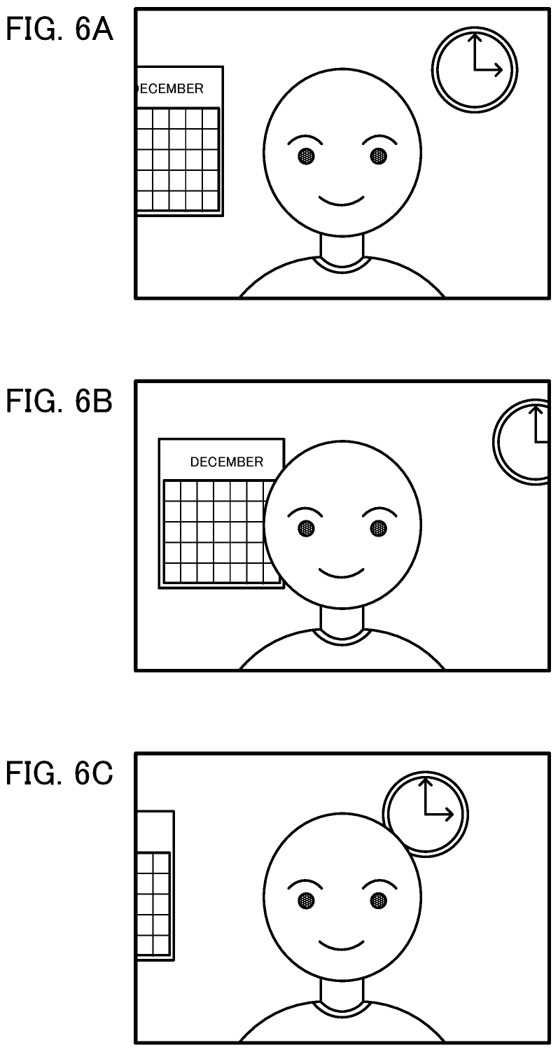

Next, with reference to FIG. 6A to FIG. 6C, the image captured when the registered information is recorded will be specifically described. FIG. 6A to FIG. 6C are diagrams illustrating an example of a plurality of images recorded in the authentication system according to the second example embodiment.

The example illustrated in FIG. 6A is an image of the target captured for the first time, for example. The image includes the face of the target, and a clock and a calendar that are the environment. The example illustrated in FIG. 6B is an image of the target captured for the second time. Compared with FIG. 6A, the imaging angle is shifted in a left direction (specifically, a left direction when viewed from the camera 20) in the image. Therefore, the position of the clock and calendar that are the environment, is shifted to a right side in comparison with FIG. 6A. The example illustrated in FIG. 6C is an image of the target captured for the third time. Compared with FIG. 6A, the imaging angle is shifted in a right direction (a right direction when viewed from the camera 20) in this image. Therefore, the position of the clock and the calendar that are the environment is shifted to a left side in comparison with FIG. 6A.

As described above, in the authentication system 10 according to the second example embodiment, a plurality of images are captured at different imaging angles, and the face information, the environment information, and the imaging angle information obtained from the plurality of images are stored in the registered information storage unit 130 as the registered information. Here, an example in which the camera 20 is shifted in a horizontal direction is described, but a plurality of images may be captured in a vertical direction or a diagonal direction, for example. The registered information may be stored by using more than three images.

### (Display Example in Imaging)

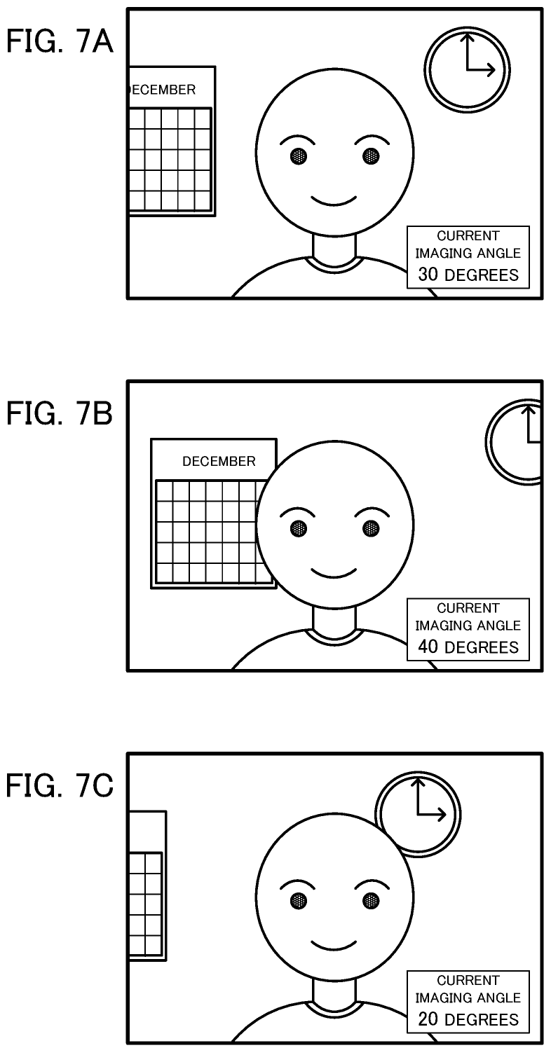

Next, with reference to FIG. 7A to FIG. 7C, a display example when a plurality of images are captured. FIG. 7A to FIG. 7C are diagrams illustrating the display example when the images are captured in the authentication system according to the second example embodiment.

As illustrated in FIG. 7, in the authentication system 10 according to the second example embodiment, the image obtained from the camera 20 may be displayed to the user such that the user can see what type of image is captured. In this case, a current imaging angle (in other words, a value obtained as the imaging angle information) may be superimposed and displayed on the image to be captured. In this way, the user can easily know at what angle the image is captured. Therefore, for example, when a specific value of the imaging angle is set as an execution condition of the authentication process (e.g., such a condition that the authentication process is performed when the imaging angle is 30 degrees), the user is allowed to capture the image while confirming the current imaging angle. In the example in FIG. 7A to FIG. 7C, a numerical value of the imaging angle is displayed, but an indicator or a level indicating the imaging angle may be also displayed, for example.

### Technical Effect

Next, a technical effect obtained by the authentication system 10 according to the second example embodiment will be described.

As described in FIG. 5 to FIG. 7C, in the authentication system 10 according to the second example embodiment, the registered information is stored by using a plurality of images that are captured while changing the imaging angle. In this way, the registered information corresponding to a plurality of imaging angles is stored, and it is thus possible to perform a proper authentication process in accordance with the imaging angle at the time of authentication. In addition, at the time of authentication, the authentication is completed when the obtained information matches any of a plurality of pieces registered information. Thus, the user is allowed to easily perform the authentication.

### Third Example Embodiment

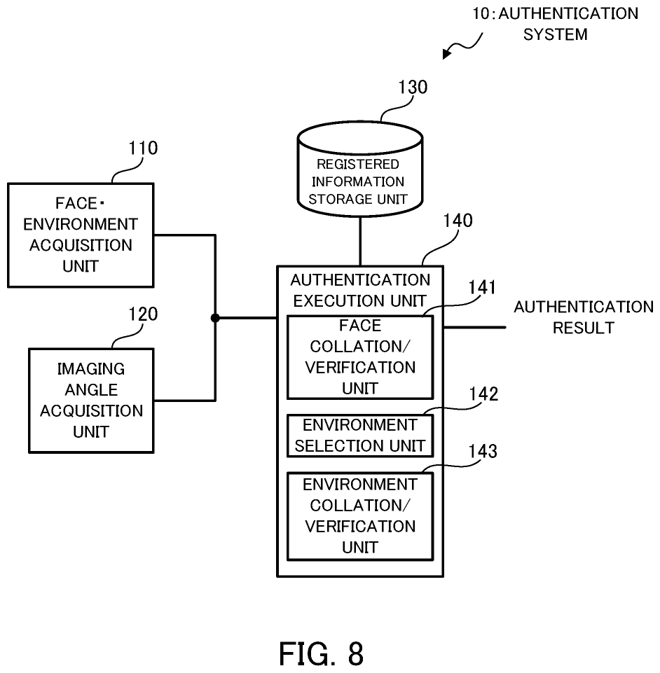

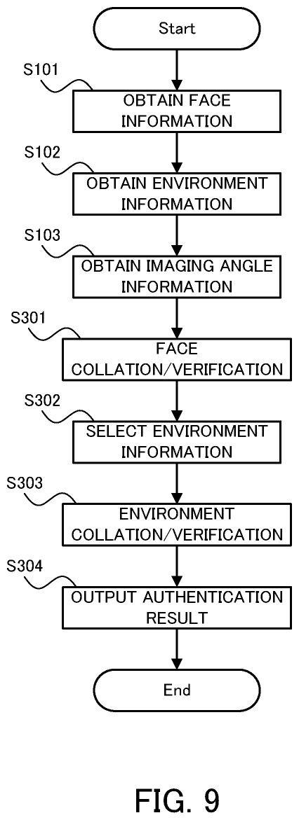

The authentication system 10 according to a third example embodiment will be described with reference to FIG. 8 and FIG. 9. The third example embodiment is partially different from the first and second example embodiments only in the configuration and operation, and may be the same as the first example embodiment in the other parts. For this reason, a part that is different from each of the example embodiments described above will be described in detail below, and a description of other overlapping parts will be omitted as appropriate.

### (Functional Configuration)

First, with reference to FIG. 8, a functional configuration of the authentication system 10 according to the third example embodiment will be described. FIG. 8 is a block diagram illustrating the functional configuration of the authentication system according to the third example embodiment. In FIG. 8, the same components as those illustrated in FIG. 2 carry the same reference numerals.

As illustrated in FIG. 8, the authentication system 10 according to the third example embodiment includes, as processing blocks for realizing the functions thereof, the face/environment acquisition unit 110, the imaging angle acquisition unit 120, the registered information storage unit 130, and the authentication execution unit 140. Especially in the authentication system 10 according to the third example embodiment, the authentication execution unit 140 includes a face collation/verification unit 141, an environment selection unit 142, and an environment collation/verification unit 143. Each function of the face collation/verification unit 141, the environment selection unit 142, and the environment collation/verification unit 143 may be realized or implemented by a separate apparatus. For example, the function of the face collation/verification unit 141 may be realized or implemented by an edge terminal (e.g., a smartphone, etc.), and the functions of the environment selection unit 142 and the environment collation/verification unit 143 may be realized or implemented by a cloud (cloud server).

The face collation/verification unit 141 is configured to perform a collation/verification process of collating the face information obtained from the image of the target (i.e., the face of the target to be authenticated) with the face information stored as the registered information (i.e., the face registered in advance). The face collation/verification unit 141 may be configured to determine that these pieces of face information match when a degree of matching between the obtained face information and the stored face information is greater than or equal to a predetermined threshold, for example.

The environment selection unit 142 is configured to select the environment information corresponding to the imaging angle information from the registered information, in accordance with the imaging angle information when the image of the target is captured. In particular, the registered information storage unit 130 according to this example embodiment stores the environment information and the imaging angle information in association with each other. Therefore, the environment selection unit 142 is configured to select the environment information corresponding to the imaging angle, by using the obtained imaging angle information. For example, the environment selection unit 142 may select the environment information associated with the imaging angle information that is the closest to the obtained imaging angle information. The environment selection unit 142 typically selects one environment information corresponding to the imaging angle, but when there are a plurality of pieces of environment information in which the imaging angles are close, all of the pieces of environment information may be selected.

Furthermore, in the operation of selecting (narrowing) the environment information, position information obtained from, for example, a GPS may be used in addition to the imaging angle information. In this case, the environment image and the position information may be stored in advance in association with each other. When the environment information is selected, for example, the environment information corresponding to the position information may be narrowed from a plurality of pieces of environment information in accordance with the position information obtained by the GPS function of a smartphone, and the environment information may further be narrowed by using the imaging angle information.

In addition, when a plurality of users are registered (e.g., when the system is configured as a shared system, instead of being owned by an individual), face authentication may be performed first, and the environment image associated with the target that can be identified by the face authentication may be narrowed, and then, the environment information may be narrowed by using the imaging angle information.

The environment collation/verification unit 143 is configured to perform a collation/verification process of collating the environment information obtained from the image of the target (i.e., the environment of the target to be authenticated) with the environment information selected by the environment selection unit 142 (i.e., the environment information about the image captured at the imaging angle that is close to the current imaging angle, out of the environment information registered in advance). The environment collation/verification unit 143 may be configured to determine that these pieces of environment information match when a degree of matching between the obtained environment information and the selected environment information is greater than or equal to a predetermined threshold, for example.

### (Flow of Operation)

Next, with reference to FIG. 9, a flow of operation of the authentication system 10 according to the third example embodiment will be described. FIG. 9 is a flowchart illustrating the flow of the operation of the authentication system according to the third example embodiment. In FIG. 9, the same steps as those illustrated in FIG. 4 carry the same reference numerals.

As illustrated in FIG. 9, in operation of the authentication system 10 according to the third example embodiment, first, the face/environment acquisition unit 110 obtains the face information about the target from the image of the target (step S101). In addition, the face/environment acquisition unit 110 obtains the environment information from the image of the target (step S102). Then, the imaging angle acquisition unit 120 obtains the imaging angle information when the image is captured (step S103). The steps of obtaining the respective information (i.e., the steps S101 to S103) may be performed before or after one another, or may be performed at the same time in parallel.

Subsequently, the face collation/verification unit 141 performs the collation/verification process of collating the obtained face information with the registered face information (step S301). When these pieces of face information do not match, the subsequent steps S302 and S303 may be omitted, and a result indicating that the authentication is failed, may be outputted.

Subsequently, the environment selection unit 142 selects the environment information corresponding to the obtained imaging angle information (step S302). Then, the environment collation/verification unit 143 performs the collation/verification process of collating the obtained environment information with the selected environment information (step S303). The steps S301 to S303 may be performed before or after one another, or may be performed at the same time in parallel.

Then, the authentication execution unit 140 outputs the result of the authentication process (step S304). Specifically, the authentication execution unit 140 may output a result indicating that the authentication process is successful when the collation/verification process performed on the face information by the face collation/verification unit 141 and the collation/verification process performed on the environment information by the environment collation/verification unit 143 are both successful (i.e., matching). On the other hand, the authentication execution unit 140 may output a result indicating that the authentication process is failed when one of the collation/verification process performed on the face information by the face collation/verification unit 141 and the collation/verification process performed on the environment information by the environment collation/verification unit 143 is failed (i.e., not matching).

### (Technical Effect)

Next, a technical effect obtained by the authentication system 10 according to the third example embodiment will be described.

As described in FIG. 8 and FIG. 9, in the authentication system 10 according to the third example embodiment, first, the environment corresponding to the imaging angle is selected, and the authentication process using the environment is performed. In this way, it is possible to perform a proper authentication process in view of a change in the environment caused by a difference in the imaging angle.

The authentication execution unit 140 according to the third example embodiment may be configured without the environment selection unit 142 (i.e., may include only the face collation/verification unit 141 and the environment collation/verification unit 143). In this case, the environment collation/verification unit 143 may perform the collation/verification process against all of the pieces of registered environment information.

The authentication system 10 according to the third example embodiment may be realized or implemented in combination with the authentication system 10 according to the second example embodiment (i.e., the configuration that images are captured from a plurality of angles).

### Fourth Example Embodiment

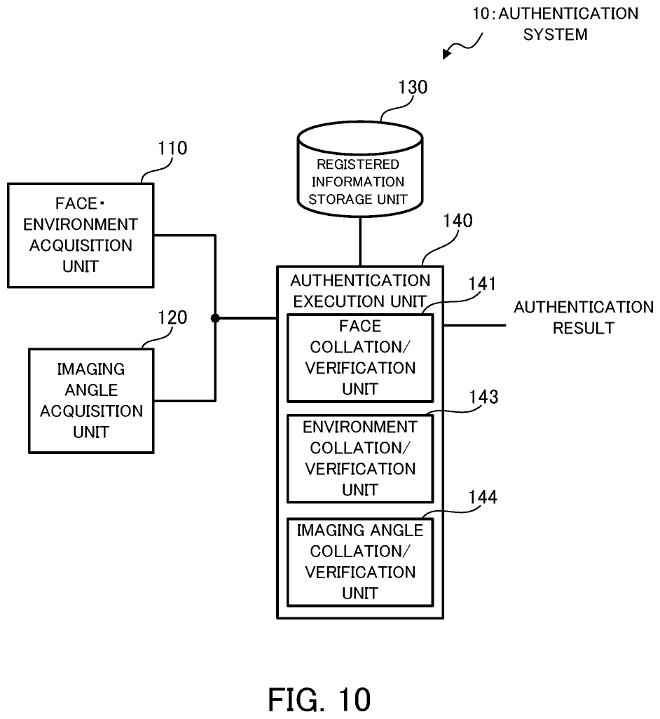

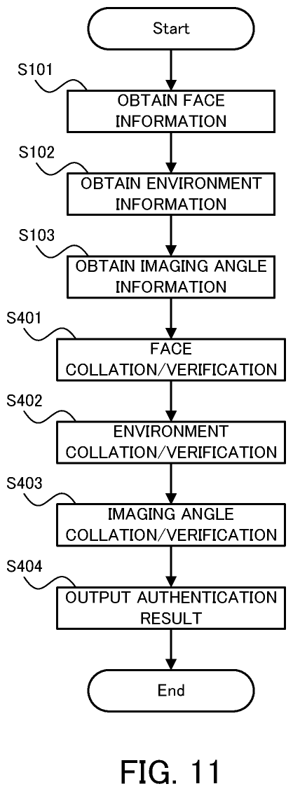

The authentication system 10 according to a fourth example embodiment will be described with reference to FIG. 10 and FIG. 11. The fourth example embodiment is partially different from the first to third example embodiments only in the configuration and operation, and may be the same as the first to third example embodiments in the other parts. For this reason, a part that is different from each of the example embodiments described above will be described in detail below, and a description of other overlapping parts will be omitted as appropriate.

### (Functional Configuration)

First, with reference to FIG. 10, a functional configuration of the authentication system 10 according to the fourth example embodiment will be described. FIG. 10 is a block diagram illustrating the functional configuration of the authentication system according to the fourth example embodiment. In FIG. 10, the same components as those illustrated in FIG. 2 and FIG. 8 carry the same reference numerals.

As illustrated in FIG. 10, the authentication system 10 according to the fourth example embodiment includes, as processing blocks for realizing the functions thereof, the face/environment acquisition unit 110, the imaging angle acquisition unit 120, the registered information storage unit 130, and the authentication execution unit 140. Especially in the authentication system 10 according to the fourth example embodiment, the authentication execution unit 140 includes the face collation/verification unit 141, the environment collation/verification unit 143, and an imaging angle collation/verification unit 144. The authentication execution unit 140 according to the fourth example embodiment does not include the environment selection unit 142 (see FIG. 8) described in the third example embodiment, but includes the imaging angle collation/verification unit 144.

The imaging angle collation/verification unit 144 is configured to perform a collation/verification process of collating the obtained imaging angle information (i.e., the imaging angle when the image for authentication is captured) with the registered imaging angle information (the imaging angle stored in advance). The imaging angle collation/verification unit 144 may determine that these pieces of imaging angle information match when a difference between the obtained imaging angle information and the stored imaging angle information is less than or equal to a predetermined threshold, for example.

### (Flow of Operation)

Next, with reference to FIG. 11, a flow of operation of the authentication system 10 according to the fourth example embodiment will be described. FIG. 11 is a flowchart illustrating the flow of the operation of the authentication system according to the fourth example embodiment. In FIG. 11, the same steps as those illustrated in FIG. 4 carry the same reference numerals.

As illustrated in FIG. 11, in operation of the authentication system 10 according to the fourth example embodiment, first, the face/environment acquisition unit 110 obtains the face information about the target from the image of the target (step S101). In addition, the face/environment acquisition unit 110 obtains the environment information from the image of the target (step S102). Then, the imaging angle acquisition unit 120 obtains the imaging angle information when the image is captured (step S103). The steps of obtaining the respective information (i.e., the steps S101 to S103) may be performed before or after one another, or may be performed at the same time in parallel.

Subsequently, the face collation/verification unit 141 performs the collation/verification process of collating the obtained face information with the registered face information (step S401). Then, the environment verification unit 143 performs the collation/verification process of collating the obtained environment information with the registered environment information (step S402). In the fourth example embodiment, the environment information corresponding to the imaging angle is not selected as in the third example embodiment. Thus, the environment verification unit 143 performs the collation/verification process against to a plurality of pieces of registered environment information.

Subsequently, the imaging angle collation/verification unit 144 performs the collation/verification process of collating the obtained imaging angle information with the registered imaging angle information (step S403). The imaging angle collation/verification unit 144 may determine whether or not the obtained imaging angle matches the imaging angle information associated with the face information or the environment information that is matched in the collation/verification process described above. The steps S401 to S403 may be performed before or after one another, or may be performed at the same time in parallel.

Then, the authentication execution unit 140 outputs the result of the authentication process (step S404). Specifically, authentication execution unit 140 may output a result indicating that the authentication process is successful when the collation/verification process performed on the face information by the face collation/verification unit 141, the collation/verification process performed on the environment information by the environment collation/verification unit 143, and the collation/verification process performed on the imaging angle information by the imaging angle collation/verification unit 144 are all successful (i.e., matching). On the other hand, the authentication execution unit 140 may output a result indicating that the authentication process is failed when any of the collation/verification process performed on the face information by the face collation/verification unit 141, the collation/verification process performed on the environment information by the environment collation/verification unit 143, and the collation/verification process performed on the imaging angle information by the imaging angle collation/verification unit 144 is failed (i.e., not matching).

### Technical Effect

Next, a technical effect obtained by the authentication system 10 according to the fourth example embodiment will be described.

As described in FIG. 10 and FIG. 11, in the authentication system 10 according to the fourth example embodiment, the collation/verification process is performed on each of the face information, the environment information, and the imaging angle information. In this way, it is possible to increase a security level of the authentication process, and it is possible to properly prevent a fraud caused by spoofing or the like.

### Fifth Example Embodiment

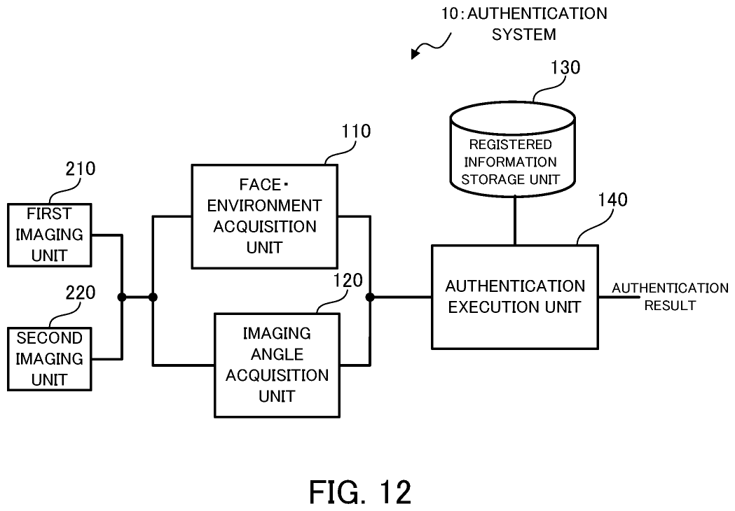

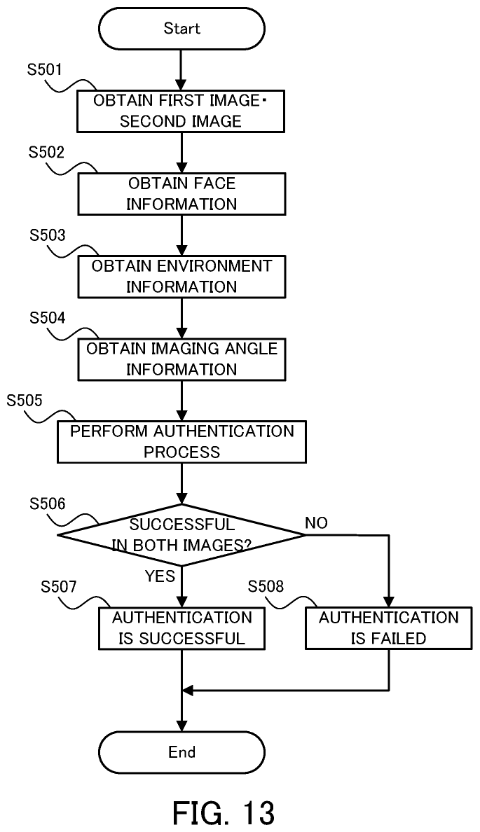

The authentication system 10 according to a fifth example embodiment will be described with reference to FIG. 12 and FIG. 13. The fifth example embodiment is partially different from the first to fourth example embodiments only in the configuration and operation, and may be the same as the first to fourth example embodiments in the other parts. For this reason, a part that is different from each of the example embodiments described above will be described in detail below, and a description of other overlapping parts will be omitted as appropriate.

### (Functional Configuration)

First, with reference to FIG. 12, a functional configuration of the authentication system 10 according to the fifth example embodiment will be described. FIG. 12 is a block diagram illustrating the functional configuration of the authentication system according to the fifth example embodiment. In FIG. 12, the same components as those illustrated in FIG. 2 carry the same reference numerals.

As illustrated in FIG. 12, the authentication system 10 according to the fifth example embodiment includes, as processing blocks for realizing the functions thereof, the face/environment acquisition unit 110, the imaging angle acquisition unit 120, the registered information storage unit 130, and the authentication execution unit 140. Especially in the authentication system 10 according to the fifth example embodiment, the face/environment acquisition unit 110 and the imaging angle acquisition unit 120 are configured to obtain the face information, the environment information, and the imaging angle information from each of the first imaging unit 210 and the second imaging unit 220.

The first imaging unit 210 and the second imaging unit 220 are configured as imaging units having different imaging ranges. Specifically, the first imaging unit 210 has a first imaging range. The second imaging unit 220 has a second imaging range that is different from the first imaging range. The first imaging unit 210 and the second imaging unit 220, are allowed to perform the imaging at the same time and to capture two images having different imaging ranges, for example. The first imaging unit 210 and the second imaging unit 220 may be configured as an in-camera and an out-camera provided by a common terminal (e.g., a smartphone), for example.

The target may be included in at least one of the image captured by the first imaging unit 210 and the image captured by the second imaging unit 220. That is, one of the image captured by the first imaging unit 210 and the image captured by the second imaging unit 220 may be an image including only an environment part.

### (Flow of Operation)

Next, with reference to FIG. 13, a flow of operation of the authentication system 10 according to the fifth example embodiment will be described. FIG. 13 is a flowchart illustrating the flow of the operation of the authentication system according to the fifth example embodiment. In FIG. 13, the same steps as those illustrated in FIG. 2 carry the same reference numerals.

As illustrated in FIG. 13, in operation of the authentication system 10 according to the fifth example embodiment, first, the image is obtained from each of the first imaging unit 210 and the second imaging unit 220 (step S501). In the following, the image captured by the first imaging unit 210 is referred to as a first image, and the image captured by the second imaging unit 220 is referred to as a second image.

Subsequently, the face/environment acquisition unit 110 obtains the face information about the target from at least one of the first image and the second image (step S502). The face/environment acquisition unit 110 obtains the environment information from each of the first image and the second image (step S503). The face/environment acquisition unit 110 may obtain only the face information from the first image, and may obtain only the environment information from the second target. Then, the imaging angle acquisition unit 120 obtains the imaging angle information when the first image and the second image are captured (step S504). When a relative angle of the first imaging unit 210 and the second imaging unit 220 is fixed, the imaging angle acquisition unit 120 may obtain one imaging angle that is common to the first image and the second image.

Subsequently, the authentication execution unit 140 performs the authentication process, on the basis of the face information, the environment information, and the imaging angle information obtained from the first image and the second image, and the registered information (step S505). The authentication execution unit 140 determines whether or not the authentication is successful in both the first image and the second image (step S506). That is, the authentication execution unit 140 determines whether or not the result of the authentication process performed on the face information, the environment information, and the imaging angle information obtained from the first image, and the result of the authentication process performed on the face information, the environment information, and the imaging angle information obtained from the second image, are both successful.

When the authentication is successful in both the first image and the second image (step S506: YES), the authentication executable unit 140 outputs information indicating that the authentication process is successful (step S507). On the other hand, when the authentication is failed in at least one of the first image and the second image (step S506: NO), the authentication execution unit 140 outputs information indicating that the authentication process is failed (step S508).

Here, such a configuration that the image is obtained from the two imaging units that are the first imaging unit 210 and the second imaging unit 220 is exemplified, but the image may be obtained from three or more imaging units, for example. In this case, the same authentication process may be performed by using a plurality of images captured by the respective imaging units.

### Technical Effect

Next, a technical effect obtained by the authentication system 10 according to the fifth example embodiment will be described.

As described in FIG. 12 and FIG. 13, in the authentication system 10 according to the fifth example embodiment, the authentication process is performed by using a plurality of images captured by different imaging units. In this way, it is required that the authentication process is successful in the plurality of images. Thus, compared with the case of performing the authentication process by using only a single image, it is possible to increase a security level of the authentication process.

### Sixth Example Embodiment

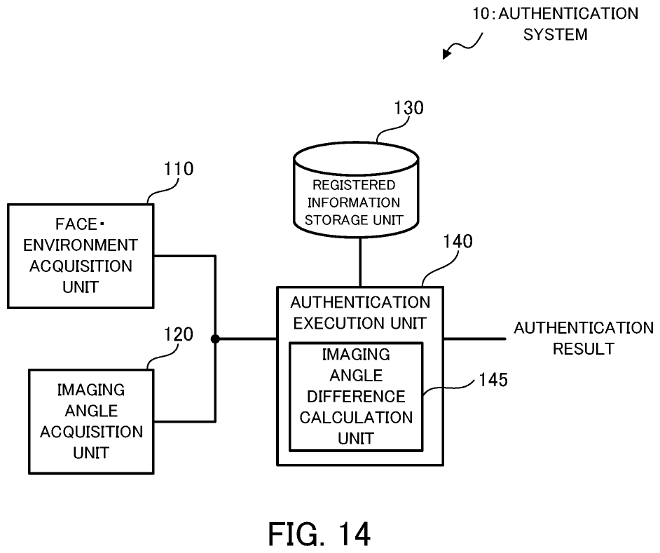

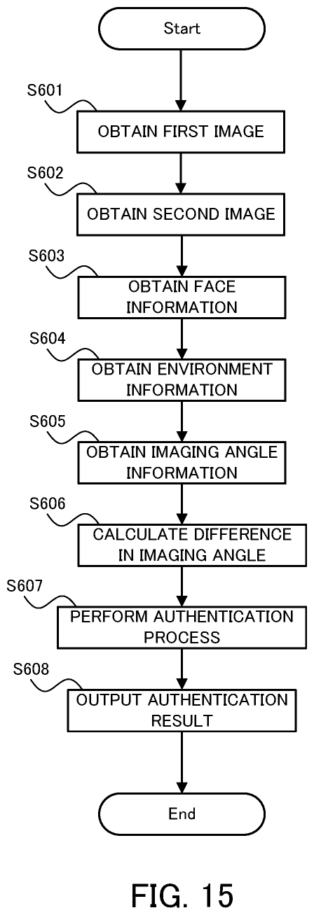

The authentication system 10 according to a sixth example embodiment will be described with reference to FIG. 14 and FIG. 15. The sixth example embodiment is partially different from the first to fifth example embodiments only in the operation, and may be the same as the first to fifth example embodiments in the other parts. For this reason, a part that is different from each of the example embodiments described above will be described in detail below, and a description of other overlapping parts will be omitted as appropriate.

### (Functional Configuration)

First, with reference to FIG. 14, a functional configuration of the authentication system 10 according to the sixth example embodiment will be described. FIG. 14 is a block diagram illustrating the functional configuration of the authentication system according to the sixth example embodiment. In FIG. 14, the same components as those illustrated in FIG. 2 carry the same reference numerals.

As illustrated in FIG. 14, the authentication system 10 according to the sixth example embodiment includes, as processing blocks for realizing the functions thereof, the face/environment acquisition unit 110, the imaging angle acquisition unit 120, the registered information storage unit 130, and the authentication execution unit 140. Especially in the authentication system 10 according to the sixth example embodiment, the authentication execution unit 140 includes an imaging angle difference calculation unit 145.

The imaging angle difference calculation unit 145 is configured to calculate a difference in the imaging angle information corresponding to a plurality of images captured at different timings. Specifically, the imaging angle difference calculation unit 145 is configured to calculate a difference between the imaging angle information for the first image captured at a first timing and the imaging angle information for the second image captured at a second timing. The difference in the imaging angle information calculated here is information indicating how the user moves the camera 20 when the plurality of images are captured. For example, when the first image is captured at 90 degrees in the vertical direction and at 0 degrees in the lateral direction and the second image is captured at 80 degrees in the vertical direction and at 0 degrees in the lateral direction, the difference in the imaging angle information is calculated as 10 degrees in the vertical direction.

The authentication execution unit 140 according to the sixth example embodiment is configured to perform the authentication process by using the difference in the imaging angle information calculated as described above. The authentication execution unit 140 may determine whether or not the difference in the imaging angle information matches the registered information, for example. For example, the authentication execution unit 140 may determine whether or not the user moves the camera 20 as registered when the first image and the second image are captured. In this case, the authentication execution unit 140 may determine that the authentication is successful when the user moves the camera as registered (i.e., when the difference in the imaging angle information matches the registered information), and may determine that the authentication is failed when the user does not move the camera as registered (i.e., when the difference in the imaging angle information is different from the registered information). The authentication execution unit 140 may perform the authentication process by using the imaging angle information itself, in addition to the difference in the imaging angle information.

### (Flow of Operation)

Next, with reference to FIG. 15, a flow of operation of the authentication system 10 according to the sixth example embodiment will be described. FIG. 15 is a flowchart illustrating the flow of the operation of the authentication system according to the sixth example embodiment.

As illustrated in FIG. 15, in operation of the authentication system 10 according to the sixth example embodiment, first, the first image of the target captured at the first timing is obtained (step S601). Then, the second image of the target captured at the second timing that is different from the first timing is obtained (step S602).

Subsequently, the face/environment acquisition unit 110 obtains the face information about the target from the obtained first image and the obtained second image of the target (step S603). The face/environment acquisition unit 110 obtains the environment information from the obtained first image and the obtained second image of the target (step S604). Then, the imaging angle acquisition unit 120 obtains the imaging angle information when the first image and the second image of the target are captured (step S605). The steps S603 to S605 may be performed before or after one another, or may be performed at the same time in parallel.

Subsequently, the imaging angle difference calculation unit 145 calculates the difference between the imaging angle information about the first image and the imaging angle information about the second image (step S606). Then, the authentication execution unit 140 performs the authentication process, on the basis of the face information, the environment information, and the difference in the imaging angle information obtained from the images of the target, and the registered information (step S607). Then, the authentication execution unit 140 outputs the result of the authentication process (step S608).

### Technical Effect

Next, a technical effect obtained by the authentication system 10 according to the sixth example embodiment will be described.

As described in FIG. 14 and FIG. 15, in the authentication system 10 according to the sixth example embodiment, the authentication process is performed, on the basis of the difference between the imaging angles of the plurality of images captured at different timings, in addition to the face information and the environment information. In this way, since it is also considered how to change the imaging angle when a plurality of images are captured, it is possible to perform the authentication process more properly.

### Seventh Example Embodiment

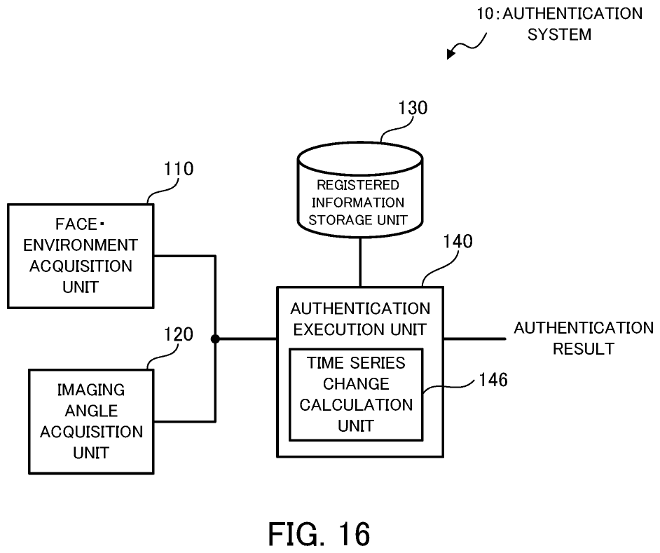

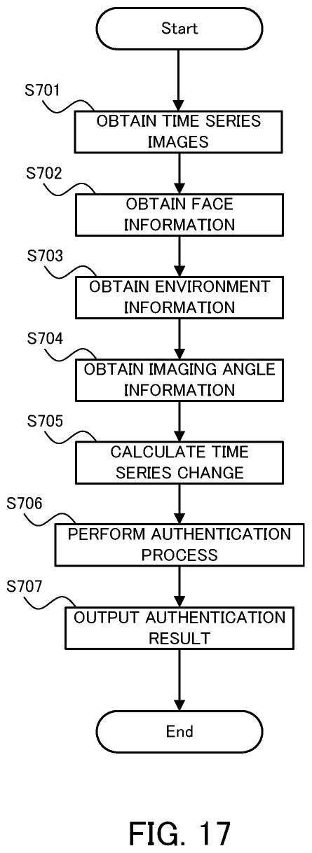

The authentication system 10 according to a seventh example embodiment will be described with reference to FIG. 16 and FIG. 17. The seventh example embodiment is partially different from the first to sixth example embodiments only in the operation, and may be the same as the first to sixth example embodiments in the other parts. For this reason, apart that is different from each of the example embodiments described above will be described in detail below, and a description of other overlapping parts will be omitted as appropriate.

### (Functional Configuration)

First, with reference to FIG. 16, a functional configuration of the authentication system 10 according to the seventh example embodiment will be described. FIG. 17 is a block diagram illustrating the functional configuration of the authentication system according to the seventh example embodiment. In FIG. 17, the same components as those illustrated in FIG. 2 carry the same reference numerals.

As illustrated in FIG. 17, the authentication system 10 according to the seventh example embodiment includes, as processing blocks for realizing the functions thereof, the face/environment acquisition unit 110, the imaging angle acquisition unit 120, the registered information storage unit 130, and the authentication execution unit 140. Especially in the authentication system 10 according to the seventh example embodiment, the authentication execution unit 140 includes a time series change calculation unit 146.

The time series change calculation unit 146 is configured to calculate a change in the environment information and a change in the imaging angle information, on the basis of a plurality of time series images (typically, images of respective frames of a video) captured in a time series. Specifically, the time series change calculating unit 146 may calculate how the environment information in the time series images is changed (e.g., how a background information is changed over time). The time series change calculating unit 146 may calculate how the imaging angle information in the time series images is changed (e.g., how the angle of the camera 20 is changed over time).

The authentication execution unit 140 according to the seventh example embodiment performs the authentication process by using the change in the environment information and the change in the imaging angle information. For example, the authentication execution unit 140 may determine whether or not the background of the images is changed correctly in accordance with the movement of the camera 20. More specifically, the authentication execution unit 140 may determine whether an object that was on a right side appears in the images when the camera is moved to the right. The authentication execution unit 140 may determine whether or not the imaging angle is as expected when the background is changed. More specifically, when the background is gradually changed, the authentication execution unit 140 may determine whether or not the imaging angle information is correctly changed from 88 degrees to 89 degrees and to 90 degrees (in other words, whether the angle is not an abnormal value, or whether the angle is not abruptly changed) may be determined.

### (Flow of Operation)

Next, with reference to FIG. 17, a flow of operation of the authentication system 10 according to the seventh example embodiment will be described. FIG. 17 is a flowchart illustrating the flow of the operation of the authentication system according to the seventh example embodiment.

As illustrated in FIG. 17, in operation of the authentication system 10 according to the seventh example embodiment, first, a plurality of time series images are obtained (step S701). The time series images may be obtained collectively after all the time series images are captured, or may be obtained sequentially during the imaging.

Subsequently, the face/environment acquisition unit 110 obtains the face information about the target from the obtained time series images (step S702). In addition, the face/environment acquisition unit 110 obtains the environment information from the obtained time series images (step S704). Then, the imaging angle acquisition unit 120 obtains the imaging angle information when each of the time series images is captured (step S705). The steps S702 to S705 may be performed before or after one another, or may be performed at the same time in parallel.

Subsequently, the time series change calculating unit 146 calculates the change in the time series images in the time series (specifically, the change in the environment information, and the change in the imaging angle information) (step S705). The authentication execution unit 140 performs the authentication process, on the basis of the face information, the change in the environment information, and the change in the imaging angle information obtained from the images of the target, and the registered information (step S706). Then, authentication execution unit 140 outputs the result of the authentication process (step S707).

### Technical Effect

Next, a technical effect obtained by the authentication system 10 according to the seventh example embodiment will be described.

As described in FIG. 16 and FIG. 17, in the authentication system 10 according to the seventh example embodiment, the authentication process is performed, on the basis of the change in the environment information in the time series and the change in the imaging angle information in the time series, in addition to the face information. In this way, since it is also considered how the environment information is changed and how the imaging angle is changed when the time series images are captured, it is possible to perform the authentication process more properly.

### Eighth Example Embodiment

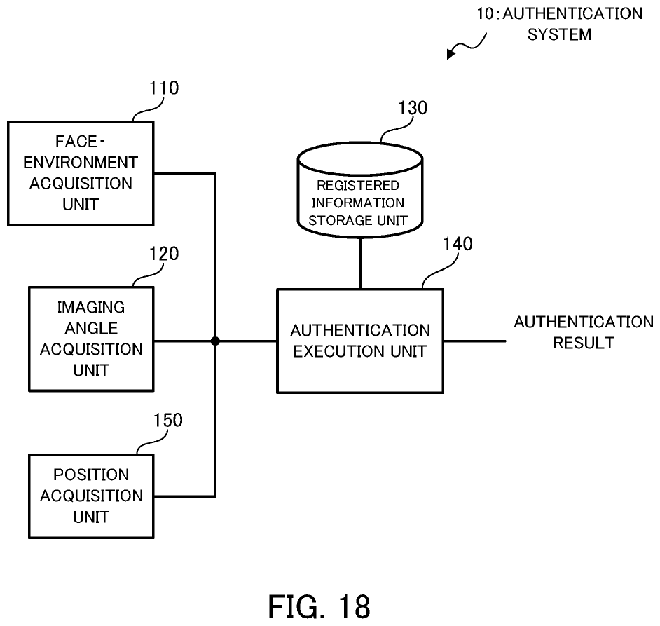

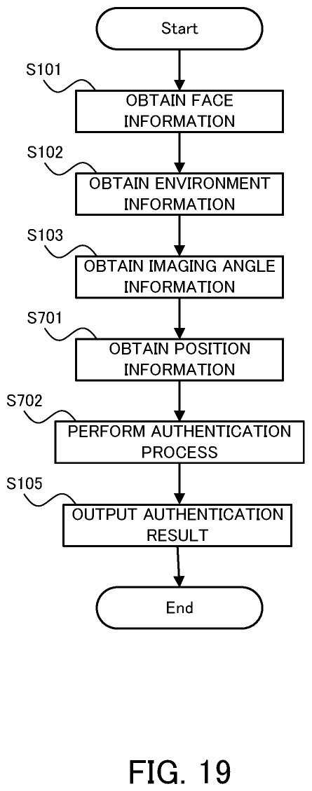

The authentication system 10 according to an eighth example embodiment will be described with reference to FIG. 18 and FIG. 19. The eighth example embodiment are partially different from the first to seventh example embodiments only in the configuration and operation, and may be the same as the first to seventh example embodiments in the other parts. For this reason, a part that is different from each of the example embodiments described above will be described in detail below, and a description of other overlapping parts will be omitted as appropriate.

### (Functional Configuration)

First, with reference to FIG. 18, a functional configuration of the authentication system 10 according to the eighth example embodiment will be described. FIG. 18 is a block diagram illustrating the functional configuration of the authentication system according to the eighth example embodiment. In FIG. 18, the same components as those illustrated in FIG. 2 carry the same reference numerals.

As illustrated in FIG. 18, the authentication system 10 according to the eighth example embodiment includes, as processing blocks for realizing the functions thereof, the face/environment acquisition unit 110, the imaging angle acquisition unit 120, the registered information storage unit 130, the authentication execution unit 140, and a position acquisition unit 150. That is, the authentication system 10 according to the eighth example embodiment further includes the position acquisition unit 150, in addition to the configuration in the first example embodiment (see FIG. 2).

The position acquisition unit 150 is configured to obtain information about a position where the image of the target is captured (hereinafter referred to as a “position information” as appropriate). The position acquisition unit 150 may be configured to obtain the position information about a terminal that captures the image, for example. The position acquisition unit 150 may be configured to obtain the position information by using a GPS (Global Positioning System), for example. The position information obtained by the position acquisition unit 150 is configured to be outputted to the authentication execution unit 140.

### (Flow of Operation)

Next, with reference to FIG. 19, a flow of operation of the authentication system 10 according to the eighth example embodiment will be described. FIG. 19 is a flowchart illustrating the flow of the operation of the authentication system according to the eighth example embodiment. In FIG. 19, the same steps as those illustrated in FIG. 4 carry the same reference numerals.

As illustrated in FIG. 19, in operation of the authentication system 10 according to the eighth example embodiment, first, the face/environment acquisition unit 110 obtains the face information about the target from the image of the target (step S101). In addition, the face/environment acquisition unit 110 obtains the environment information from the image of the target (step S102). Then, the imaging angle acquisition unit 120 obtains the imaging angle information when the image is captured (step S103). The steps of obtaining the respective information (i.e., the steps S101 to S103) may be performed before or after one another, or may be performed at the same time in parallel.

In the eighth example embodiment, furthermore, the position acquisition unit 150 obtains the position information when the image of the target is captured (step S701). A process of obtaining the position information may be performed before or after the process of obtaining the other information (i.e., the steps S101 to S103), or may be performed at the same time in parallel

Subsequently, the authentication execution unit 140 performs the authentication process, on the basis of the obtained face information, the obtained environment information, the obtained imaging angle information, and the obtained positional information, and the registered information (step S702). The authentication execution unit 140 outputs the result of the authentication process (step S703).

The registered information according to this example embodiment includes the position information in addition to the face information, the environment information, and the imaging angle information. Therefore, in the authentication process, a collation/verification process of collating the obtained position information with the registered position information may be performed. Alternatively, the position information may be used as information for narrowing the other information (i.e., the face information, the environment information, and the imaging angle information) (e.g., as information for selecting the information that is used for the collation/verification, such as the imaging angle information in the third example embodiment).

### Technical Effect

Next, a technical effect obtained by the authentication system 10 according to the eighth example embodiment will be described.

As described in FIG. 18 and FIG. 19, in the authentication system 10 according to the eighth example embodiment, the authentication process is performed by using the position information, in addition to the face information, the environment information, and the imaging angle information. In this way, it is possible to perform the authentication process more properly, compared with the case of not using the position information (i.e., the case of using only the face information, the environment information, and the imaging angle information).

### Ninth Example Embodiment

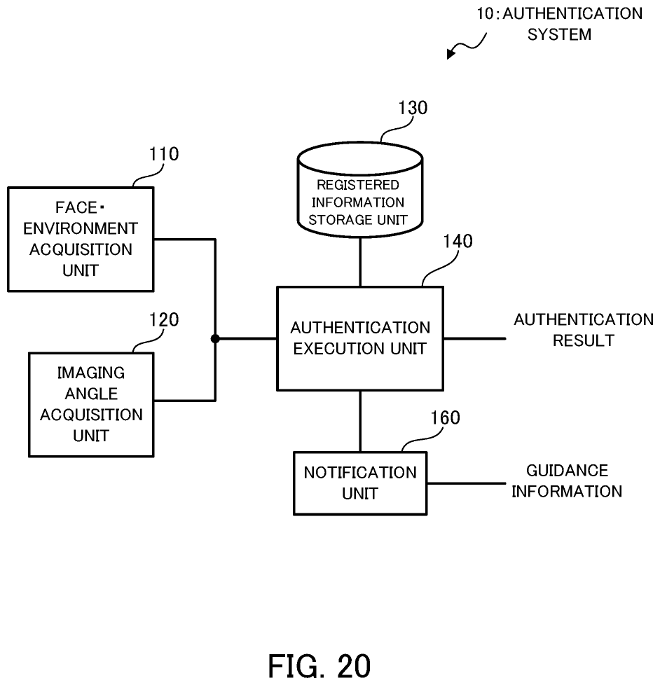

The authentication system 10 according to a ninth example embodiment will be described with reference to FIG. 20 to FIG. 23. The authentication system 10 according to the ninth example embodiment is partially from the first to eighth example embodiments only in the configuration and operation, and may be the same as the first to eighth example embodiments in the other parts. For this reason, a part that is different from each of the example embodiments described above will be described in detail below, and a description of other overlapping parts will be omitted as appropriate.

### (Functional Configuration)

First, with reference to FIG. 20, a functional configuration of the authentication system 10 according to the ninth example embodiment will be described. FIG. 20 is a block diagram illustrating the functional configuration of the authentication system according to the ninth example embodiment. In FIG. 20, the same components as those illustrated in FIG. 2 carry the same reference numerals.

As illustrated in FIG. 20, the authentication system 10 according to the ninth example embodiment includes, as processing blocks for realizing the functions thereof, the face/environment acquisition unit 110, the imaging angle acquisition unit 120, the registered information storage unit 130, the authentication execution unit 140, and a notification unit 160. That is, the authentication system 10 according to the ninth example embodiment further includes the notification unit 160, in addition to the configuration in the first example embodiment (see FIG. 2).

The notification unit 160 is configured to notify the target to be authenticated, to change a condition of capturing the image. More specifically, the notification unit 160 is configured to make a notification when the obtained face information matches the registered face information (i.e., the face collation/verification is successful), but the obtained environment information or the obtained imaging angle information does not match the registered environment information or imaging angle information (i.e., the environment collation/verification or the imaging angle collation/verification is not successful) on the authentication execution unit 140. The notification unit 160 may make a notification by using a display, a speaker, or the like provided by the output apparatus 16 (see FIG. 1), for example. The notification unit 160 may make a notification in conjunction with the result of the authentication process.

### Specific Display Examples

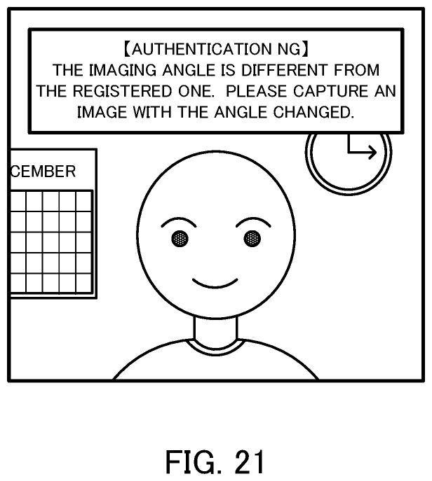

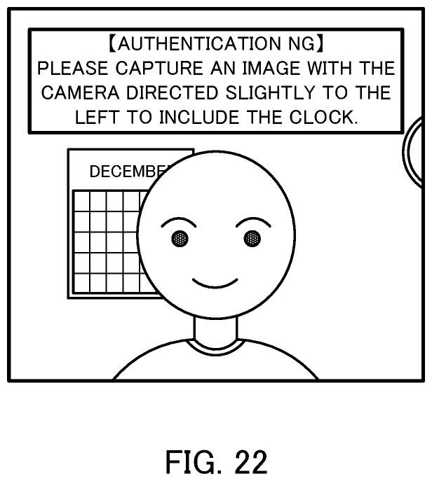

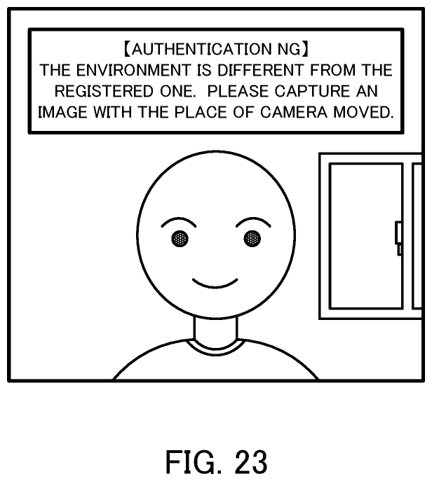

Next, with reference to FIG. 21 to FIG. 23, notification examples (display examples) by the authentication system 10 according to the ninth example embodiment will be specifically described. FIG. 21 is version 1 of a diagram illustrating a display example in the authentication system according to the ninth example embodiment. FIG. 22 is version 2 of a diagram illustrating a display example in the authentication system according to the ninth example embodiment. FIG. 23 is version 3 of a diagram illustrating a display example in the authentication system according to the ninth example embodiment.

In the example illustrated in FIG. 21, in addition to a message of “authentication NG” indicating that the authentication process is failed, such a message that “The image angle is different from the registered one. Please capture an image with the angle changed.” is displayed. Such a notification is made in a situation where the face collation/verification of the target is successful, but the collation/verification of the environment or imaging angle is failed. That is, such a notification is made in a situation where the target is likely to be the registered user, but the authentication process is failed because the environment or the imaging angle is different from the registered one. In this case, when the target is a person in question (or a genuine user), it is likely that the authentication will be successful by changing the imaging angle and capturing the image again. Therefore, it is possible to avoid a situation where the person in question is rejected.

In the example illustrated in FIG. 22, in addition to a message of “authentication NG” indicating that authentication process is failed, such a message that “Please capture an image with the camera directed slightly to the left to include the clock” is displayed. Such a notification is made in a situation where the face collation/verification of the target is successful, but the collation/verification of the environment or the imaging angle is failed. That is, such a notification is made in a situation where the target is likely to be the registered user, but the authentication process is failed because the environment or the imaging angle is slightly deviated. In this case, when the target is a person in question (or a genuine user), it is likely that the authentication will be successful by changing the angle of the camera and capturing the image again in accordance with the message. Therefore, it is possible to avoid a situation where the person in question is rejected.

In the example illustrated in FIG. 23, in addition to a message of “authentication NG” indicating that authentication process is failed, such a message that “The environment is different from the registered one. Please capture an image with the place of the camera moved.” is displayed. Such a notification is made in a situation where the face collation/verification of the target is successful, but the environment collation/verification is failed. That is, such a notification is made in a situation where the target is likely to be the registered user, but the authentication process is failed due to a different environment. In this case, when the target is a person in question (or a genuine user), it is likely that the authentication will be successful by moving the position of the camera and capturing the image again in accordance with the message. Therefore, it is possible to avoid a situation where the person in question is rejected.

### Technical Effect

Next, a technical effect obtained by the authentication system 10 according to the ninth example embodiment will be described.

As described in FIG. 20 to FIG. 23, in the authentication system 10 according to the ninth example embodiment, when the pieces of face information match, but the pieces of environment information do not match, a notification (an output of a guidance information) regarding an imaging method is made to the target. In this way, even when the authentication is failed due to a difference in an imaging condition, the target may be guided to perform proper imaging. Therefore, it is possible to avoid a situation where the authentication is failed even though the target is the registered user.

### Tenth Example Embodiment

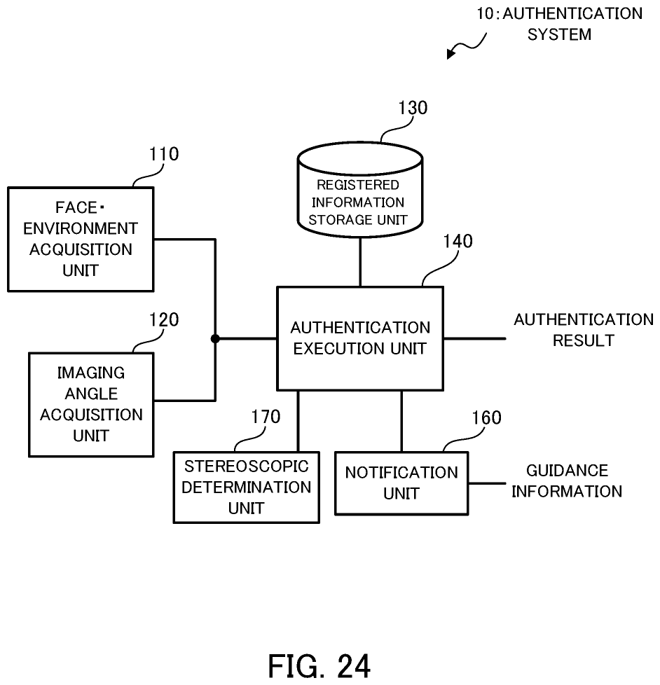

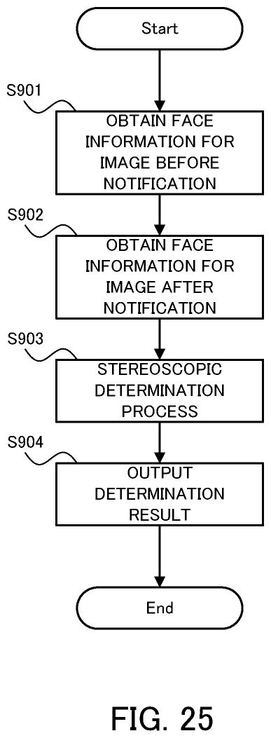

The authentication system 10 according to a tenth example embodiment will be described with reference to FIG. 24 and FIG. 25. The authentication system 10 according to the tenth example embodiment is partially different from the ninth example embodiment in the configuration and operation, and may be the same as the first to ninth example embodiments in the other parts. For this reason, a part that is different from each of the example embodiments described above will be described in detail below, and a description of other overlapping parts will be omitted as appropriate.

### (Functional Configuration)

First, with reference to FIG. 24, a functional configuration of the authentication system 10 according to the tenth example embodiment will be described. FIG. 24 is a block diagram illustrating the functional configuration of the authentication system according to the tenth example embodiment. In FIG. 24, the same components as those illustrated in FIG. 20 carry the same reference numerals.

As illustrated in FIG. 24, the authentication system 10 according to the tenth example embodiment includes, as processing blocks for realizing the functions thereof, the face/environment acquisition unit 110, the imaging angle acquisition unit 120, the registered information storage unit 130, the authentication execution unit 140, the notification unit 160, and a stereoscopic determination unit 170. That is, the authentication system 10 according to the tenth example embodiment further includes the stereoscopic determining unit 170, in addition to the configuration in the ninth example embodiment (see FIG. 20).

The stereoscopic determination unit 170 is configured to determine whether or not the face of the target is stereoscopic/three-dimensional (e.g., whether or not the face is not a face on a plane such as a paper sheet or a display). Specifically, the stereoscopic determination unit 170 is configured to determine whether or not the face of the target is stereoscopic/three-dimensional, by using the face information obtained before the notification by the notification unit 160 (in other words, the face information obtained from the image captured before the notification by the notification unit 160) and the face information obtained after the notification by the notification unit 160 (in other words, the face information obtained from the image captured after the notification by the notification unit 160).

In particular, the image captured before the notification (hereinafter referred to as an “image before the notification” as appropriate) and the image captured after the notification (hereinafter referred to as an “image after the notification” as appropriate) are captured at different angles due to the notification. The stereoscopic determination unit 170 determines whether or not the face of the target is stereoscopic/three-dimensional, by using the image before the notification and the image after the notification in which the imaging angles are different. The stereoscopic determination unit 170 may be configured to determine whether or not the face of the target is stereoscopic/three-dimensional, by using a plurality of images captured from different angles, even if they are not the image before the notification and the image after the notification.

### (Flow of Operation)

Next, a flow of operation of the stereoscopic determination unit 170 will be described with reference to FIG. 25. FIG. 25 is a flowchart illustrating a flow of a stereoscopic determination operation in the authentication system according to the tenth example embodiment.

As illustrated in FIG. 25, first, the stereoscopic determination unit 170 in the authentication system 10 according to the tenth example embodiment obtains the face information for the image before the notification (step S901). The face information for the image before the notification may be obtained before the notification by the notification unit 160, or may be obtained after the notification. The stereoscopic determination unit 170 obtains the face information for the image after the notification (step S902).

Subsequently, the stereoscopic determination unit 170 determines whether or not the face of the target is stereoscopic/three-dimensional, on the basis of the face information for the image before the notification and the face information for the image after the notification (step S903). The stereoscopic determination unit 170 outputs a determination result (i.e., information indicating whether or not the face of the target is stereoscopic/three-dimensional) (step S904).

The determination result by the stereoscopic determination unit 170 may be outputted to the authentication execution unit 140, for example. In this case, the authentication execution unit 140 may perform the authentication process, on the basis of the determination result by the stereoscopic determination unit 170. The determination result by the stereoscopic determination unit 170 may be outputted as another information that is separate from the authentication result of the authentication execution unit 140. In this case, the determination result by the stereoscopic determination unit 170 may be outputted from the output apparatus 16 (e.g., a display, a speaker, or the like).

### Technical Effect

Next, a technical effect obtained by the authentication system 10 according to the tenth example embodiment will be described.

As described in FIG. 24 and FIG. 25, in the authentication system 10 according to the tenth example embodiment, it is determined whether or not the face of the target is stereoscopic/three-dimensional, by using the image before the notification and the image after the notification. In this way, it is possible to determine whether or not the face of the target is stereoscopic/three-dimensional (in other words, whether or not the target is genuine), and thus, it is possible to prevent a fraud caused by spoofing using a paper, a display, or the like, for example.

A processing method in which a program for allowing the configuration in each of the example embodiments to operate to realize the functions of each example embodiment is recorded on a recording medium, and in which the program recorded on the recording medium is read as a code and executed on a computer, is also included in the scope of each of the example embodiments. That is, a computer-readable recording medium is also included in the range of each of the example embodiments. Not only the recording medium on which the above-described program is recorded, but also the program itself is also included in each example embodiment.

The recording medium to use may be, for example, a floppy disk (registered trademark), a hard disk, an optical disk, a magneto-optical disk, a CD-ROM, a magnetic tape, a nonvolatile memory card, or a ROM. Furthermore, not only the program that is recorded on the recording medium and executes processing alone, but also the program that operates on an OS and executes processing in cooperation with the functions of expansion boards and another software, is also included in the scope of each of the example embodiments.

This disclosure is not limited to the examples described above and is allowed to be changed, if desired, without departing from the essence or spirit of this disclosure which can be read from the claims and the entire specification. An authentication system, ab authentication apparatus, an authentication method, and a recording medium with such changes are also intended to be within the technical scope of this disclosure.

### Supplementary Notes

The example embodiments described above may be further described as, but not limited to, the following Supplementary Notes below.

### Supplementary Note 1

An authentication system according to Supplementary Note 1 is an authentication system including: a first acquisition unit that obtains face information and environment information of a target, from an image including the target; a second acquisition unit that obtains imaging angle information that is information indicating an angle when the image is captured; and an authentication execution unit that performs an authentication process on the target, on the basis of the obtained face information, the obtained environment information, and the obtained imaging angle information.

### Supplementary Note 2

An authentication system according to Supplementary Note 2 is the authentication system according to Supplementary Note 1, further including a storage unit that stores the face information, the environment information, and the imaging angle information that are obtained by performing a plurality of times of imaging by changing an image angle, in advance as registered information, wherein the storage unit stores a plurality of pieces of environment information and a plurality of pieces of imaging angle information in association with each other, and the authentication execution unit selects the environment information corresponding to the obtained imaging angle information, from the registered information, and determines that the authentication process is successful when the obtained environment information matches the selected environment information and the obtained face information matches registered face information.

### Supplementary Note 3

An authentication system according to Supplementary Note 3 is the authentication system according to Supplementary Note 1 or 2, wherein the first acquisition unit obtains a plurality of pieces of face information from a first imaging unit having a first imaging range, and obtains a plurality of pieces of environment information from a second imaging unit having a second imaging range that is different from the first imaging range, the second acquisition unit obtains the imaging angle information when the first imaging unit and the second imaging unit capture the image, and the authentication execution unit performs the authentication process, on the basis of the face information and the environment information obtained from the first acquisition unit, and the imaging angle information obtained from the second acquisition unit.

### Supplementary Note 4

An authentication system according to Supplementary Note 4 is the authentication system according to any one of Supplementary Notes 1 to 3, wherein the first acquisition unit obtains the face information and the environment information from a first image captured at a first timing and a second image captured at a second timing, the second acquisition unit obtains the imaging angle information when the first image and the second image are captured, and the authentication execution unit performs the authentication process, on the basis of the face information and the environment information obtained from the first image and the second image, and a difference between the imaging angle information for the first image and the imaging angle information for the second image.

### Supplementary Note 5

An authentication system according to Supplementary Note 5 is the authentication system according to any one of Supplementary Notes 1 to 3, wherein the first acquisition unit obtains the face information and the environment information from a plurality of time series images captured in a time series, the second acquisition unit obtains the imaging angle information when each of the time series images is captured, and the authentication execution unit performs the authentication process, on the basis of the face information, a change in the environment information in the time series, and a change in the imaging angle information in the time series.

### Supplementary Note 6

An authentication system according to Supplementary Note 6 is the authentication system according to any one of Supplementary Notes 2 to 5, further including a third acquisition unit that obtains position information when the image is captured, wherein the storage unit stores the positional information as the registered information, in addition to the face information, the environment information, and the imaging angle information, and the authentication execution unit performs the authentication process, on the basis of the obtained face information, the obtained environment information, the obtained imaging angle information, the obtained positional information, and the registered information.

### Supplementary Note 7

An authentication system according to Supplementary Note 7 is the authentication system according to any one of Supplementary Notes 1 to 6, further including a notification unit that notifies the target to change a condition of capturing the image, when the obtained face information matches registered face information, but the obtained environment information or the obtained imaging angle information does not match registered environment information or registered imaging angle information in the authentication process.

### Supplementary Note 8

An authentication system according to Supplementary Note 8 is the authentication system according to Supplementary Note 7, further including a stereoscopic determination unit that determines whether or not a face of the target is stereoscopic/three-dimensional, by using the face information obtained before the target is notified by the notification unit and the face information obtained after the target is notified by the notification unit.

### Supplementary Note 9

An authentication apparatus according to Supplementary Note 8 is an authentication apparatus including: a first acquisition unit that obtains face information and environment information of a target, from an image including the target; a second acquisition unit that obtains imaging angle information that is information indicating an angle when the image is captured; and an authentication execution unit that performs an authentication process on the target, on the basis of the obtained face information, the obtained environment information, and the obtained imaging angle information.

### Supplementary Note 10

An authentication method according to Supplementary Note 10 is an authentication method including: obtaining face information and environment information of a target, from an image including the target; obtaining imaging angle information that is information indicating an angle when the image is captured; and performing an authentication process on the target, on the basis of the obtained face information, the obtained environment information, and the obtained imaging angle information.

### Supplementary Note 11

A recording medium according to Supplementary Note 11 is a recording medium on which a computer program that allows a computer to execute an authentication method is recorded, the authentication method including: obtaining face information and environment information of a target, from an image including the target; obtaining imaging angle information that is information indicating an angle when the image is captured; and performing an authentication process on the target, on the basis of the obtained face information, the obtained environment information, and the obtained imaging angle information.

### Supplementary Note 12

A computer program according to Supplementary Note 12 is a computer program that allows a computer to execute an authentication method, the authentication method including: obtaining face information and environment information of a target, from an image including the target; obtaining imaging angle information that is information indicating an angle when the image is captured; and performing an authentication process on the target, on the basis of the obtained face information, the obtained environment information, and the obtained imaging angle information.

### DESCRIPTION OF REFERENCE CODES

10 Authentication system
11 Processor
14 Storage apparatus
20 Camera
21 Sensor
110 Face/environment acquisition unit
120 Imaging angle acquisition unit
130 Registered information storage unit
140 Authentication execution unit
141 Face collation/verification unit
142 Environment selection unit
143 Environment collation/verification unit
144 Imaging angle collation/verification unit
145 Imaging angle difference calculation unit
146 Time series change calculation unit
150 Position acquisition unit
160 Notification unit
170 Stereoscopic determination unit
210 First imaging unit
220 Second imaging unit

What is claimed is:

1. An authentication system comprising:
at least one memory that is configured to store instructions; and
at least one processor that is configured to execute the instructions to
obtain face information and environment information of a target, from an image including the target;
obtain imaging angle information that is information indicating an angle when the image is captured; and
perform an authentication process on the target, on the basis of the obtained face information, the obtained environment information, and the obtained imaging angle information.

2. The authentication system according to claim 1, wherein the at least one processor is configured to execute the instructions to
store the face information, the environment information, and the imaging angle information that are obtained by performing a plurality of times of imaging by changing an image angle, in advance as registered information,
store a plurality of pieces of environment information and a plurality of pieces of imaging angle information in association with each other,
select the environment information corresponding to the obtained imaging angle information, from the registered information, and
determine that the authentication process is successful when the obtained environment information matches the selected environment information and the obtained face information matches registered face information.

3. The authentication system according to claim 1, wherein
the at least one processor is configured to execute the instructions to
obtain a plurality of pieces of face information from a first imaging unit having a first imaging range, and obtains a plurality of pieces of environment information from a second imaging unit having a second imaging range that is different from the first imaging range,
obtain the imaging angle information when the first imaging unit and the second imaging unit capture the image, and
perform the authentication process, on the basis of the obtained face information and the obtained environment information, and the obtained imaging angle information.

4. The authentication system according to claim 1, wherein
the at least one processor is configured to execute the instructions to
obtain the face information and the environment information from a first image captured at a first timing and a second image captured at a second timing,
obtain the imaging angle information when the first image and the second image are captured, and
perform the authentication process, on the basis of the face information and the environment information obtained from the first image and the second image, and a difference between the imaging angle information for the first image and the imaging angle information for the second image.

5. The authentication system according to claim 1, wherein
the at least one processor is configured to execute the instructions to
obtain the face information and the environment information from a plurality of time series images captured in a time series,
obtain the imaging angle information when each of the time series images is captured, and
perform the authentication process, on the basis of the face information, a change in the environment information in the time series, and a change in the imaging angle information in the time series.

6. The authentication system according to claim 2, wherein the at least one processor is configured to execute the instructions to
obtain position information when the image is captured,
store the positional information as the registered information, in addition to the face information, the environment information, and the imaging angle information, and
perform the authentication process, on the basis of the obtained face information, the obtained environment information, the obtained imaging angle information, the obtained positional information, and the registered information.

7. The authentication system according to claim 1, wherein the at least one processor is configured to execute the instructions to notify the target to change a condition of capturing the image, when the obtained face information matches registered face information, and the obtained environment information or the obtained imaging angle information does not match registered environment information or registered imaging angle information in the authentication process.

8. The authentication system according to claim 7, wherein the at least one processor is configured to execute the instructions to determine whether or not a face of the target is stereoscopic, by using the face information obtained before the target is notified and the face information obtained after the target is notified.

9. (canceled)

10. An authentication method comprising:
obtaining face information and environment information of a target, from an image including the target;
obtaining imaging angle information that is information indicating an angle when the image is captured; and
performing an authentication process on the target, on the basis of the obtained face information, the obtained environment information, and the obtained imaging angle information.

11. A non-transitory recording medium on which a computer program that allows a computer to execute an authentication method is recorded, the authentication method including:
obtaining face information and environment information of a target, from an image including the target;
obtaining imaging angle information that is information indicating an angle when the image is captured; and
performing an authentication process on the target, on the basis of the obtained face information, the obtained environment information, and the obtained imaging angle information.
